(19) United States
(12) Patent Application Publication
(10) Pub. No.: US 2001/0056197 A1
(43) Pub. Date: Dec. 27, 2001

(54) Ormocers, method for their production, and their use

(76) Inventors: Philipp Albert, Hanau (DE); Gerd Lohden, Hanau (DE); Corinna Gall, Schluchtern (DE); Bjorn Borup, Munchen (DE)

Correspondence Address: SMITH, GAMBRELL & RUSSELL, LLP, SUITE 800, 1850 M STREET, N.W., WASHINGTON, DC, 20036, US

(21) Appl. No.: 09/811,822

(22) Filed: Mar. 20, 2001

(30) Foreign Application Priority Data
Mar. 31, 2000 (DE) 100 16 324.6

(51) Int. Cl. C07F 1/00

(52) U.S. Cl. 556/9

(57) ABSTRACT

Ormocers, which can be obtained by the hydrolytic condensation of one or more silicon compounds, and the subsequent polymerization of organic monomers, wherein at least one silicon compound comprises vinyl ether radicals of formula (I):

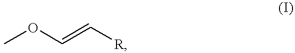

wherein R represents hydrogen, methyl, or ethyl. The new ormocers are used in dental materials.

### INTRODUCTION AND BACKGROUND

The present invention concerns ormocers, which can be obtained by the hydrolytic condensation of one or more silicon compounds, a method for their production, and their use.

Ormocers are a new class of composite materials made of atomic ceramic and plastic networks, which combine and interpenetrate with one another. The name ORMOCER is an abbreviation for “ORganically MOdified CERamics.”

The production of these polymers which are reminiscent of silicones takes place according to a sol-gel process, in the presence of acidic or basic catalysts. Ormocers are, accordingly, inorganic-organic polymers. They generally have a surface area of 10-50 m²/g.

Ormocers are, in fact, known. Thus, for example, WO 92/16 571 describes a composite material, which is obtained by the hydrolysis of silicon compounds that contain ethylenically unsaturated groups, and the subsequent polymerization of the released organic monomers.

The organic monomers are said to form an organic network either by radical initiators or by ring-opening polymerization. In particular, (meth)acrylate compounds and norbomene derivatives are disclosed.

The disadvantage when using (meth)acrylates is, in particular, the shrinkage which appears due to the radical polymerization. Moreover, released methacrylates are harmful to human health.

Moreover, the radical polymerization is inhibited by atmospheric oxygen. This leads to the formation of a so-called lubrication layer, which can lead to a low adhesion of the cured ormocers. This effect is, in particular, undesired when using ormocers as a filler material in dental materials.

If monomers are used that are polymerized by a ring opening, a low rate of reaction frequently results. Moreover, their reaction is relatively low, so that the mechanical characteristics of the composite material are disadvantageously influenced. Furthermore, discoloration can appear, depending on the ring-opening catalysts used.

Moreover, ormocers are known whose organic monomers are obtained by the cationic polymerization of trioxaspiro compounds. The monomers exhibit a greatly reduced shrinkage, in comparison to the traditional methacrylate monomers. The disadvantage here, however, is that the production of these spiro compounds is expensive and therefore, these monomers are very expensive.

These known ormocers are, for example, disclosed in DE-A-41 33 494. They are used as dental resin compositions, in particular, for the filling of carious cavities. Accordingly, the low rate of polymerization of the spiroeta compounds is an extremely serious disadvantage.

An object of the present invention is, therefore, to obtain ormocers whose organic network can be polymerized at a high rate, without thereby causing a high volume contraction.

Another object of the invention is the production of composite materials of the aforementioned type, which have a high wear resistance, high degree of hardness, high toughness, high compressive strength, and an excellent scratch resistance of the surface, after the curing of the organic matrix.

A further object of the invention is to provide cured ormocers that exhibit an excellent polishing capacity.

### SUMMARY OF THE INVENTION

The above and other objects of the invention can be achieved from ormocers which can be obtained by the hydrolytic condensation of one ore more silicon compounds and the subsequent polymerization of organic monomers.

In carrying out the invention at least one silicon compound comprises a vinyl ether radical of formula (I):

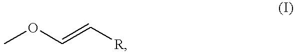

wherein R represents hydrogen, methyl, or ethyl. It is possible to make ormocers available, in a nonforseeable manner, by the hydrolytic condensation of one or more silicon compounds and subsequently, the polymerization of organic monomers whose organic network can be cured at a high rate, without thereby causing a high volume contraction.

As a result of the present invention, the following advantages can be attained:

The completely cured ormocers exhibit a high durability, a high compressive strength, an excellent polishing capacity, a high scratch resistance of the surface, an excellent modulus of elasticity, and a high adhesive force, for example, on enamel or on dentin.

Moreover, the starting compounds of ormocers, in accordance with the invention, can be produced at low cost and can be easily obtained.

Furthermore, the ormocers exhibit only an extremely slight shrinkage or no shrinkage at all when the organic matrix is cured.

Another advantage of ormocers, in accordance with the invention, is the particular ease of photochemically curing the organic matrix, wherein the composite material can be processed particularly easily before the organic matrix is cured.

### DETAILED DESCRIPTION OF INVENTION

As mentioned in the above, “ormocers,” which are designated to some extent as “ormosils,” are also composite materials which have a network of organic and inorganic polymers intertwined in one another. The expression “network” designates a three-dimensional arrangement of substances covalently bound to one another. The organic network fills empty sites of the inorganic network, so that the two networks are firmly bound to one another.

In this connection, “inorganic” means that the main chains are formed, in particular, of —Si—O— bonds, which can be both linear as well as branched. The Si atoms of the inorganic network can be replaced, partially, by other metal or semimetal atoms, such as Al, B, Zr, Y, Ba, and/or Ti.

The organic network is obtained by the polymerization of organic monomers, in particular, vinyl ether radicals, wherein other monomers, which can be copolymerized with vinyl ether radicals of formula (I), can be included.

The organic network of ormocers, in accordance with the invention, can be obtained by the hydrolytic condensation of one or more silicon compounds, wherein preferred silicon compounds are monomeric silanes of formula (II):

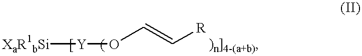

wherein R denotes, independently, hydrogen, methyl or ethyl;

R¹, denotes independently, an aliphatic, cycloaliphatic, or aromatic radical with 1 to 30 carbon atoms;

X, is a hydrolyzable group;

Y, is independently, an unsubstituted or substituted aliphatic, cycloaliphatic or aromatic radical with 1 to 30 carbon atoms, wherein one or more CH₂ groups can be replaced by O, C═O, —CO₂—, —SiR₂—, and/or —SiR₂O—;

and a represents a whole number in the range of 1 to 3;

b, is a whole number in the range of 0 to 2;

and n, is a whole number in the range from 1 to 3;

or cyclic, branched or linear oligo- or polysiloxanes, comprising structural units of formula (III):

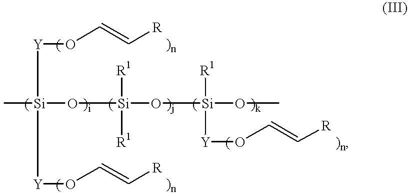

wherein R, R¹, and Y and the number n have the aforementioned meanings; i, j, and k are, independently, a whole number in the range of 0 to 15, wherein, however, i and k cannot simultaneously be 0.

The aliphatic groups are alkenyl and/or alkyl radicals with 1-30, preferably 1-20 carbon atoms, and particularly, 1-6 carbon atoms, and can be straight-chain, branched, or cyclic.

Special examples of alkyl groups are methyl, ethyl, n-propyl, iso-propyl, n-butyl, s-butyl, t-butyl, iso-butyl, n-pentyl, n-hexyl.

Moreover, cycloalkyl groups are comprised which have one or more ring systems. Special examples are cyclopentyl, cyclohexyl, and norbonyl.

Among others, vinyl, allyl, 2-butenyl, cyclopentenyl, and cyclohexenyl belong to the alkenyl groups.

Moreover, the silanes of formulas (I), (II), or (III) can also include aromatic groups. Phenyl, biphenylyl, and naphthyl belong to the preferred aryl groups.

These groups can, optionally, carry one or more substituents—for example, halogen, alkyl, hydroxyalkyl, alkenyl, alkoxy, aryl, aryloxy, aralkyl, acyloxy, alkylcarbonyl, alkoxycarbonyl, furfuryl, tetrahydrofurfuryl, amino, alkylamnino, dialkylamino, trialkylammonium, amido, hydroxy, formyl, carboxy, mercapto, cyano, nitro, and epoxyl.

Hydrolyzable groups are groups released by water. Among others, hydroxy groups, halogens, in particular fluorine, chlorine, and bromine, aryloxy, alkoxy, and/or acyloxy groups belong to these groups. The hydrolyzable groups are designated as X in formulas (II) and (III), wherein the Y group, depending on the structure, can also be released, under certain circumstances, by water.

The alkoxy, aryloxy, acyloxy, and alkylcarbonyl groups can be preferably derived from the aforementioned alkyl and aryl groups. Among others, methoxy, ethoxy, n- and iso-propoxy, n-, iso-, s-, and t-butoxy, acetyloxy, propionyloxy, methylcarbonyl, ethylcarbonyl, methoxycarbonyl, benzyloxy, 2-phenylethyloxy, and tolyloxy, belong to these groups. These groups can also have the aforementioned substituents.

Special examples of silicon compounds of formula (I) are (4-(vinyloxymethyl)cyclohexyl)methoxyethyltrimethoxysilane; (4-(vinyloxymethyl)phenyl)methoxyethyltrimethoxysilane, 3,5-divinyloxyphenyldimethylchlorosilane; 1,2-di(4-(1-propenyloxymethyl)cyclohexyl)methoxyethyl-1,2-dimethyl-1,2-dimethoxysiloxane, and 1,3,5,7-tetra[(4-(1-propenyloxy)methyl)cyclohexyl)methoxyethyl]-1,3,5,7-tetramethylcyclotetrasiloxane. These compounds can also be used as mixtures.

The aforementioned silanes or siloxanes can be obtained commercially in bulk for the most part; moreover, they can be obtained synthetically in a known manner. The aforementioned X and Y groups can serve as reference points. The person skilled in the art can find helpful indications, moreover, for example, from Ullmann's Encyclopedia of Industrial Chemistry, 5th Edition.

The production of vinyl compounds from vinyl halides and alkoxides was, in particular, described by W. Reppe et al., Justus Liebigs Ann. Chem. 601 (1956), 81-110. Moreover, transvinylation reactions are known, in which a vinyl group of a vinyl ether or ester is transferred to an alcohol or an acid. One can mention the following literature references, by way of example: N. D. Field et al.: “Vinyl Ethers,” in High Polymers, Vol. 24, Wiley, New York, 1971, pp. 365-411; S. A. Miller: “Vinyl Ethers,” in Acetylene, Its Properties, Manufacture and Uses, Vol. 2, Ernest Benn Ltd., London, 1966, pp. 198-231; D. H. Lorenz: Encyclopedia of Polymer Science and Technology, Vol. 14, Interscience, New York, 1971, pp. 504-510.

Moreover, vinyl groups can be obtained from allyl groups by isomerization reactions. The isomerization can take place both by the addition of a base and also by the action of Ru catalysts, such as (Ph₃P)₃RuCl₂.

The preparation of silicon-organic compounds frequently takes place via chlorosilanes, which can generally be obtained commercially. They can, for example, be reacted in ethereal solution with Grignard reagents (for example, RMgI) to form alkylsilanes or arylsilanes. For the production of Si—H bond-containing organosilanes, the reduction of the corresponding organohalogen silanes with lithium aluminum hydride used in hydrosilylation reactions can be enlisted.

The aforementioned siloxanes can be obtained, for example, from the corresponding hydrogen siloxanes by hydrosilylation with (1-propenoxy)vinyloxyalkanes. Here, the vinyloxy group reacts mainly with the Si—H bond of the hydrogen siloxane. For the catalysis of this reaction, Pt, Rh, and/or Pd compounds are generally used. Among others, Karsted and Wilkinson catalysts are known.

(1-Propenoxy)vinyloxyalkanes can be obtained, for example, by isomerization from allyloxyvinyloxyalkanes. The specialist can find valuable indications in this regard in, for example, J. V. Crivello, G. Lohden: “Synthesis and Photopolymerization of 1-Propenyl Ether Functional Siloxanes” in Chem. Mater., 1996, 8, 209-218.

The mixture from which the inorganic networks of ormocers, in accordance with the invention, can be obtained by hydrolytic condensation can have additional semimetal and metal compounds, which are incorporated into the inorganic network during the hydrolysis.

Among others, additional silanes, which do not have a vinyl ether group of formula (I), belong to these compounds.

Examples of these are CH₃—Si—Cl₃, CH₃—Si—(OC₂H₅)₃, C₂H₅—Si—Cl₃, C₂H₅—Si—(OCH₃)₃, CH₂═CH—Si—(OC₂H₄OCH₃)₃, (CH₃)₂—Si—Cl₂, (CH₃)₂—Si—Br₂.

Furthermore, the mixtures from which ormocers, in accordance with the invention, can be produced can have hydrolyzable aluminum compounds, wherein preferred embodiments can be represented by the general formula AlR²₃, wherein the groups R² can be the same or different and are halogens, alkoxys, alkoxycarbonyls, alkyls, aryls, and hydroxys. Particularly preferred groups are deduced from the groups which were mentioned for silicon compounds, by way of example.

Aluminum alkoxides and aluminum halides belong to the preferred aluminum compounds of the aforementioned type. Special examples are Al(OCH₃)₃, Al(OC₂H₅)₃, Al(OC₃H₇)₃, Al(OC₄H₉)₃, AlCl₃, and AlCl(OH)₂.

Moreover, hydrolyzable titanium or zirconium compounds can be cohydrolyzed with the silicon compounds. Preferred compounds can be represented by the general formula MXₒR¹ₜ, wherein M denotes Ti or Zr; X and R¹ have the meaning mentioned in formula (II); o represents a whole number of 1-4; and t, a whole number of 0-3.

Concrete examples of Zr and Ti compounds are TiCl₄, Ti(OC₂H₅)₄, Ti(OCH₃H₇)₄, Zr(OC₄H₉)₄, ZrCl₄, Zr(OC₂A₅)₄, Zr(OC₃H₇)₄, Zr(OC₄H₉)₄, and ZrOCl₂.

Moreover, boron, tin, and barium compounds can also be incorporated into the ormocers. Suitable compounds are, for example, BCl₃, B(OCH₃)₃, B(OC₂H₅)₃, SnCl₄, Sn(OCH₃)₄, Ba(OCH₃)₃, Ba(OC₂H₅)₃, and Ba(OCOCH₃)₂.

By incorporating heavy elements, in particular, Zr, Ti, or Ba into the ormocers, in accordance with the invention, it is possible to change the X-ray opacity of the composite material. Furthermore, the mechanical characteristics of the cured composite change in this way.

The mechanical characteristics can be influenced, moreover, by the ratio of the readily hydrolyzable groups, which are represented in the aforementioned formulas by X, to the less readily hydrolyzable groups, which are represented by R¹. The Y groups in the above formulas can be hydrolyzable or not, depending on the structure.

The higher the fraction of hydrolyzable groups to nonhydrolyzable groups, the harder but also more brittle will be the material. Preferably, the ratio of these groups, which is given by hydrolyzable to nonhydrolyzable, is in the range of 1:1 to 3:1, preferably 1.5:1 to 2:1, wherein this value is to be understood as the average value of hydrolyzable compounds which can be used as the mixture.

The production of the inorganic networks can take place in the way which is common in the field of poly(hetero)condensation. If silicon compounds are predominantly used, then an admixture of water, at room temperature or with a slight cooling, is sufficient for the hydrolytic condensation in most cases, wherein the resulting mixture is stirred for some time.

In the presence of reactive compounds, such as organometallic compounds of aluminum, titanium, or zirconium, a stepwise addition of the water is recommended, as a rule, wherein this can also take place diluted.

In many cases, the introduction of the amount of water into the reaction mixtures with the aid of moisture-loaded adsorbents, for example, molecular sieves, and water-containing organic solvents, such as 80% ethanol, has proved particularly suitable in many cases. In general, the hydrolytic condensation is carried out at temperatures between −20° C. and 130° C., preferably between 0 and 30° C. The reaction can take place both in a melt as well as in a solvent. Suitable solvents are, among others, aliphatic alcohols, such as ethanol or iso-propanol, ketones, in particular, dialkylketones such as acetone or methyl isobutyl ketone, ethers such as diethyl ether or dibutyl ether, THF, and esters, such as ethyl acetate.

Vinyl ether groups of formula (I) are cationically polymerizable. Accordingly, the production of the inorganic polymer matrix takes place in a neutral or basic medium This is produced either by a basic solvent, such as triethylamine, or by the addition of basic hydrolysis and condensation catalysts, such as NH₃, NaOH, KOH, and methylimidazole.

Especially when using different easily hydrolyzable compounds, it has proved to be preferable not to have present all starting compounds at the beginning of the hydrolysis, but rather to contact only a part of these compounds with water and subsequently to add other compounds. The same is true for the addition of water, which can take place in several stages, wherein after each addition of water, the mixture is stirred for a certain time. This procedure may be necessary if parts of the hydrolyzed compounds tend to precipitate.

The condensation time is based on individual starting components and their quantitative fractions, the optionally used catalyst, the reaction temperature and so forth. In general, the polycondensation takes place under normal pressure. However, it can also be carried out under elevated or reduced pressure. The polycondensed product thus obtained can be used as such or after removal of used or formed readily volatile substances, such as solvents.

For example, the polycondensed product can be added to dental materials, before the organic network is cured by suitable polymerization catalysts, photochemically and/or thermally. For the removal of volatile components, the reaction mixture can be concentrated under reduced pressure and slightly increased temperature, depending on the monomer, up to approximately 80° C.

Since the polymerization, as described below, preferably takes place cationically, the pH value should be lowered at least to the neutral point after a basically catalyzed condensation.

Preferably, the formation of the organic network takes place by cationic polymerization. Accordingly, polymerization catalysts are added to the polycondensed products or the mixtures from which these are obtained; these catalysts preferably are Lewis or Brönsted acids or compounds which release such acids, such as BF₃ or its ethereal adducts (BF₃.THF, BF₃.Et₂O, and so forth), AlCl₃, FeCl₃, HPF₆, HAsF₆, HSbF₆, HBF₄, to which, under certain circumstances, a halogenated carbon compound such as triphenylchloromethane is added, or substances, which, after irradiation by UV or visible light or by heat and/or pressure, trigger the polymerization, such as (eta-6-cumene)(eta-5-cyclopentadienyl)iron hexafluorophosphate, (eta-6-cumene)(eta-5-cyclpentadienyl)iron tetrafluoroborate, substituted diaryliodonium salts, and triarylsulfonium salts.

Usually, accelerators such as peroxy compounds, in particular of the per ester type, benzoin derivatives, benzil compounds, or acylphosphine oxides, are added to these initiators.

The ratio of initiator to accelerator can be varied within broad limits of 1:0.001 to 1:10; preferably, however, a ratio of 1:0.1 to 3:6 is used.

Particularly preferred polymerization catalysts contain iodonium salts as initiators and benzoin derivatives, such as benzoin, α-methylbenzoin methyl ether, α-dicarbonyl compounds, such as 2,3-butanedione, camphorquinone, benzil, and their derivatives, such as ω, ω-dimethoxy-ω-phenylacetophenone, α-hydroxyalkylphenone derivatives, such as 1-benzoylcyclohexan-1-ol, and aceylphosphine oxide compounds, such as benzoyldiphenylphosphine oxide, trimethylbenzoyldiphenylphosphine oxide (others are described in EP 0 073 413) as accelerators.

Particularly suitable diaryliodonium compounds are, for example, diphenyliodonium tetrafluoroborate, diphenyliodonium hexafluorophosphate, bis(4-methylphenyl)iodonium hexafluorophosphate, dinaphthyliodonium hexafluoroantimonate, and phenyl-4-methylphenyliodonium hexafluoroantimonate.

The iodonium salt-containing polymerization catalysts can frequently be initiated by UV light in the wavelength range from 200 to 400 nm. Surprisingly, it was determined that these initiators cure vinyl ether radicals of formula (1) in the polycondensed products also, particularly effectively and rapidly. It is not necessary hereby to irradiate the material during the entire curing time, since after a sufficient initiation, the dental material is completely cured. This characteristic is particularly useful with the introduction of fillings.

Before the organic network is formed, additional, ethylenically unsaturated, especially cationically polymerizable monomers can be added to the hydrolyzable silicon compound or the polymer produced therefrom.

These can be both monofunctional as well as polyfunctional monomers. Among others, vinyl esters, such as vinyl acetate, vinyl ethers, such as propyl vinyl ether, butyl vinyl ether, 2-methylpropyl vinyl ether, pentyl vinyl ether, hexyl vinyl ether, ((1-propenoxy)ethyl)trimethylsilane, ((1-propenoxy)ethy)triethylsilane, and vinyl aromatics, such as styrene, substituted styrenes with an alkyl substituent in the side chain, such as α-methylstyrene and α-ethylstyrene, substituted styrenes with an alkyl substituent on the ring, such as vinyltoluene and p-methylstyrene, halogenated styrenes, such as monochlorostyrenes, dichlorostyrenes, tribromostyrenes, and tetrabromostyrenes can be used.

Examples of polyfunctional monomers are 1,3,5-benzenetricarboxylic acid tris-4-(ethenyloxy)butanol ester; butane diacid bis(4-ethenyloxy)butanol ester; bis[4-((ethenyloxy)methyl)cyclohexyl)methyl]pentanedioate; 2,2-bis[4,1-phenyloxy-4-((ethenyloxy)methyl)cyclohexyl)methyl]propane; diphenyl ether 4,4′-dicarboxylic acid (4-((ethenyloxy)methyl)cyclohexyl)methanol diester, and diphenyl ether 4,4′-dicarboxylic acid 2-(ethenyloxy)ethanol diester.

The ormocers, in accordance with the invention, are preferably produced in that the components are mixed; afterwards, the silicon compounds are basically hydrolyzed; and subsequently, the ethylenically unsaturated radicals are cationically polymerized.

As mentioned before, ormocers are mainly used in dental materials. Dental material refers to materials for tooth fillings, inlays or onlays, dental cements, glass ionomer cements, compomers, facing materials for crowns and bridges, materials for artificial teeth, dentin bondings, basefilling materials, root filling materials or other materials for prosthetic, preserving, and preventive dentistry. In particular, the term “dental material” also refers to composites for applications in dentistry and dental technology, sealing materials, self-curing composites, stump synthesis materials, facing materials, highly and normally filled dual cements, and normally filled, fluoride-containing dental lacquers.

The ormocers, in accordance with the invention, can be used as a dental material, without adding other materials. For the improvement of processability, mechanical characteristics, and for aesthetic reasons, additional monomers, which are mentioned above, can be added as binders and additional fillers, before polymerizing the ethylenically unsaturated bonds.

The use of inorganic fillers in dental materials is, in fact, known. The fillers are used, in particular, to improve mechanical characteristics. Among others, quartzes, ground glasses, aerosils, spherical SiO₂ particles, which are optionally coated with titanium dioxide, zeolites, hard-to-dissolve fluorides, such as CaF₂, YF₃, silica gels, and pyrogenic silicic acids or their granules are, to a great extent, used as fillers. Moreover, the dental materials, in accordance with the invention, can also have organic fillers, in particular, fibers. These fillers can generally be obtained commercially.

In particular, heavy atoms, such as Y and Zr, increase X-ray opacity. Therefore, fillers which have these atoms are preferred.

For a better incorporation into the polymer matrix, these fillers can be treated with adhesion-improving agents. Among others, silanes, such as ((1-propenoxy)ethyl)trimethoxysilane, ((1-propenoxy)ethyl)triethoxysilane, or (1-propenoxy)ethyltrichlorosilane, are suitable for this.

Without creating a limitation thereby, these fillers should generally exhibit a particle size in the range of 0.02 μm to 100 μm, preferably, from 0.05 to 10 μm, and with very particular preference, from 0.1 to 5 μm, wherein the form of the fillers is not subject to any particular limitation. They can accordingly be, for example, spherical, splinter-shaped, lamellar, and/or in the shape of fibers.

These fillers can be used individually or as mixtures, wherein the use of mixtures makes possible, under certain circumstances, improvements with regard to aesthetics and a further improvement of mechanical characteristics.

The filler content of the dental materials, including the ormocers, in accordance with the invention, lies in the range of 1 to 95 wt %, preferably in the range of 50 to 90 wt%, and with very particular preference, in the range of 65 to 90 wt %, based on the total weight. A high filler content leads to a slight shrinkage, excellent mechanical characteristics, and to a good polishing capacity of the cured material. On the other hand, sufficient binder for curing must be present in the dental material. The more uniformly the binder can be incorporated in the filler, the higher the filler content can be selected.

Moreover, the dental materials of the invention under consideration can have auxiliaries. Among others, stabilizers, pigments, or diluents belong to these auxiliaries.

The cured dental material has excellent characteristics with regard to flexural strength, the modulus of elasticity, compressive strength, durability, and wear resistance.

Moreover, the dental materials of the invention under consideration have an excellent polishing capacity, a low water absorption, and excellent aesthetic characteristics, in particular, with regard to transparency and the index of refraction.

Further variations and modifications of the foregoing will be apparent to those skilled in the art and are intended to be encompassed by the claims appended hereto.

German priority application 100 16 324.6 is relied on and incorporated herein by reference.

1. An ormocer, produced by the hydrolytic condensation of one or more silicon compounds and the subsequent polymerization of organic monomers, wherein said at least one silicon compound comprises vinyl ether radicals of formula (I): 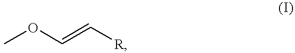
wherein R represents hydrogen, methyl, or ethyl.

2. The ormocer according to claim 1, wherein said at least one silicon compound is a monomeric silane of formula (II): 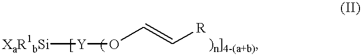
wherein R denotes, independently, hydrogen, methyl or ethyl; R¹, independently, an aliphatic, cycloaliphatic, or aromatic group with 1 to 20 carbon atoms; X, a hydrolyzable group; and Y, independently, an unsubstituted or substituted, aliphatic, cycloaliphatic or aromatic radical with 1 to 30 carbon atoms, wherein one or more CH₂ groups can be replaced by O, C═O, —CO₂—, —SiR₂—, and/or —SiR₂O—; and a represents a whole number in the range of 1 to 3; b, a whole number, in the range of 0 to 2; and n, a whole number in the range of 1 to 3; or cyclic, branched or linear oligo- or polysiloxanes, comprising structural units of formula (III): 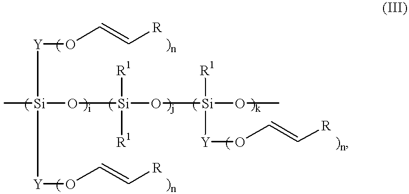
wherein R, R¹, and Y and the number n have the aforementioned meanings; i, j, and k are, independently, a whole number in the range of 0 to 15, wherein, however, i and k cannot simultaneously be 0.

3. The ormocer according to claim 1, wherein the hydrolyzable group is hydrogen, halogen, alkoxy and/or acyloxy.

4. The ormocer according to claim 2, wherein the hydrolyzable group is hydrogen, halogen, alkoxy and/or acyloxy.

5. The ormocer according to claim 1, which is obtained by hydrolytic condensation in the presence of a basic catalyst.

6. The ormocer according to claim 2, which is obtained by hydrolytic condensation in the presence of a basic catalyst.

7. The ormocer according to claim 5, the basic catalyst is NH₃, NaOH, KOH, and/or methylimidazole.

8. The ormocer according to claim 6, the basic catalyst is NH₃, NaOH, KOH, and/or methylimidazole.

9. The ormocer according to claim 1, wherein the vinyl ether radicals of formula (I) are polymerized cationically after the hydrolysis.

10. The ormocer according to claim 2, wherein the vinyl ether radicals of formula (I) are polymerized cationically after the hydrolysis.

11. The ormocer according to claim 9, wherein the polymerization is initiated by light.

12. The ormocer according to claim 10, wherein the polymerization is initiated by light.

13. The ormocer according to claim 9, wherein additional cationically polymerizable monomers are added before the cationic polymerization.

14. The ormocer according to claim 10, wherein additional cationically polymerizable monomers are added before the cationic polymerization.

15. A method for the production of an ormocer according to claim 1, comprising mixing a plurality of silicon compounds comprising vinyl ether radical of formula (I) 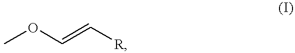
wherein R represents hydrogen, methyl or ethyl, then hydrolyzing the silicon compounds under basic conditions and subsequently cationically polymerizing ethylenically unsaturated groups.

16. A method for the production of an ormocer according to claim 1, comprising mixing a plurality of silicon compounds comprising vinyl ether radical of formula (II) 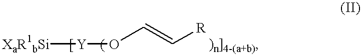
wherein R denotes, independently, hydrogen, methyl or ethyl; R¹, independently, an aliphatic, cycloaliphatic, or aromatic group with 1 to 20 carbon atoms; X, a hydrolyzable group; and Y, independently, an unsubstituted or substituted, aliphatic, cycloaliphatic or aromatic radical with 1 to 30 carbon atoms, wherein one or more CH₂ groups can be replaced by O, C═O, —CO₂—, —SiR₂—, and/or —SiR₂O—; and a represents a whole number in the range of 1 to 3; b, a whole number, in the range of 0 to 2; and n, a whole number in the range of 1 to 3; or cyclic, branched or linear oligo- or polysiloxanes, comprising structural units of formula (III): 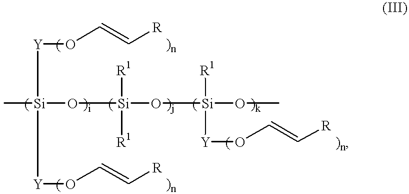
wherein R, R¹, and Y and the number n have the aforementioned meanings; i, j, and k are, independently, a whole number in the range of 0 to 15, wherein, however, i and k cannot simultaneously be 0, then hydrolyzing the silicon compounds under basis conditions and subsequently cationically polymerizing ethylenically unsaturated groups.

17. A dental material comprising a filler and the ormocer according to claim 1.

18. A dental material comprising a filler and the ormocer according to claim 2.
